(19) United States
(12) Patent Application Publication
(10) Pub. No.: US 2017/0143178 A1
(43) Pub. Date: May 25, 2017

(54) SCRUB GLOVE FOR CLEANING VARIOUS ARTICLES

(71) Applicant: Nathan Mesiti, Belleville, IL (US)

(72) Inventor: Nathan Mesiti, Belleville, IL (US)

(21) Appl. No.: 14/946,958

(22) Filed: Nov. 20, 2015

(51) Int. Cl. A47L 13/18; B32B 5/26; B32B 5/02; A41D 19/00; B08B 3/08

(52) U.S. Cl. CPC A47L 13/18; A41D 19/0055; A41D 19/0006; B08B 3/08; B32B 5/028; B32B 5/26; B32B 2432/00

(57) ABSTRACT

A cleaning utensil for expeditiously and thoroughly cleaning dirty surfaces includes an ergonomic scrub glove (10) worn by a person doing the cleaning. The scrub glove has a base portion made of a material impervious to liquids and which covers the person's hand and wrist and at least a portion of their forearm when worn. An outer layer (L) of the scrub glove comprises an abrasive woven mesh material which encases the portion of the scrub glove covering the person's hand. A cleaning solution is poured onto this outer layer for the wearer to apply the solution to a surface being cleaned by the wearer by moving their hand over and about a surface to be cleaned. The base portion of the scrub glove prevents the person's hand, wrist and forearm from coming in contact with the cleaning solution.

### CROSS REFERENCE TO RELATED APPLICATIONS

None

### STATEMENT REGARDING FEDERALLY SPONSORED RESEARCH OR DEVELOPMENT

N/A

### BACKGROUND OF THE INVENTION

This invention relates to cleaning a variety of surfaces including smooth, rough, and bumpy surfaces; and, in particular, to an ergonomic scrubbing glove worn by one cleaning the surfaces so to achieve cleaner surfaces than are achieved using conventional cleaning methods.

Cleaning surfaces whether in the kitchen, bathroom, or other rooms in the house, lawn furniture, exterior windows, siding, gutters on the outside of the house, and automotive vehicles is an unpleasant task at best. The different cleansers that have to be used attack a person's skin and are smelly. There also never seems to be enough rags or wash cloths to do the job, and most times doing the job not only takes longer than one would like, but often the results are not what the person doing the cleaning desires.

Heretofore, there has never been a simple, easy-to-use, and low cost cleaning utensil that not only achieves a good result, but also significantly shortens the amount of time required to do the job right so that the person doing the cleaning feels they have actually accomplished something. Further, conventional scrubbing and scouring utensils often require a person to grasp an object being cleaned thereby restricting the person's ergonomic capability and full functionality of their hand.

The present invention provides a significant improvement in the way cleaning both inside and outside the house is done with results that the person doing the cleaning desires.

### BRIEF SUMMARY OF THE INVENTION

The present invention is directed to a simple, easy-to-use, and low cost cleaning utensil that is ergonomically efficient and provides a thorough cleaning while significantly reducing the amount of time and bother required to clean.

The utensil comprises a glove worn by a person doing the cleaning and allows the person to expeditiously and thoroughly clean dirty surfaces whether smooth, rough, or bumpy. The glove is made of rubber or a similar liquid impervious material with a layer of an abrasive woven mesh material encasing the fingers, palm, and back of the glove wearer's hand. The rubber, base portion of the glove has a cuff extending sufficiently far up a wearer's wrist and forearm that they do not come in contact with any cleaning solutions with which the glove is used. The scrub glove covers the entirety of the wearer's hand and allows the wearer to intricately move their hand freely over and about an object being cleaned. The ergonomic scrub glove allows its wearer to conform their hand to the shape and surface of an object being cleaned and allows the wearer to apply the level of pressure required to achieve a desired cleaning result. The scrub glove provides the wearer greater control over their cleaning movements and promotes a greater efficiency in cleaning an object regardless of how detailed the surfaces of the object are.

As such, the scrub glove provides an ergonomic solution to cleaning an object; and, in particular, often relieves the wearer of having to grasp the object being cleaned. This is particularly advantageous for persons with arthritis or other movement limitations.

The glove is available in pairs so for use by right-handed or left-handed persons.

The outer layer of the glove can be wetted or saturated with a wide variety of commercial over-the-counter cleansers. A cleansing material is poured onto or over the fingers and palm of the glove with the user then scrubbing a desired surface using their fingers and palm. During a cleaning, the wearer either rubs their fingers and palm over the surface to be cleaned as well as into crevices or hard to reach places where dirt, grime, mold, etc. have accumulated.

The glove is easy to clean after use by hand rinsing in a soap solution, or by placing it in a dishwasher. When worn out, the glove is readily replaced with a new glove.

Other objects and features will be in part apparent and in part pointed out hereinafter.

### BRIEF DESCRIPTION OF THE SEVERAL VIEWS OF THE DRAWINGS

The accompanying figures, together with detailed description which follows, form part of the specification and illustrate the various embodiments described in the specification.

FIG. 1 is a plan view of right-hand and left-hand ergonomic scrub gloves of the present invention from the palm side of the respective gloves;

FIG. 2 is a plan view of the gloves from the back hand side thereof;

FIG. 3 is a side elevation view of the gloves from their respective thumb sides; and,

FIG. 4 is a partial sectional view of a multi-layer mesh material which is used to cover the glove.

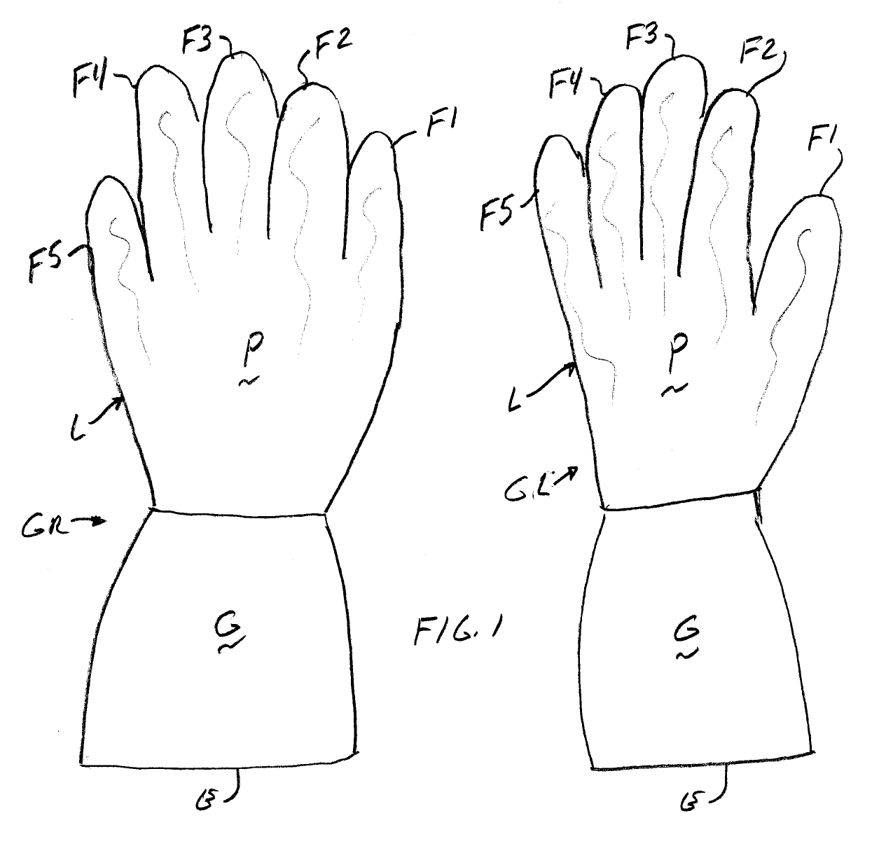

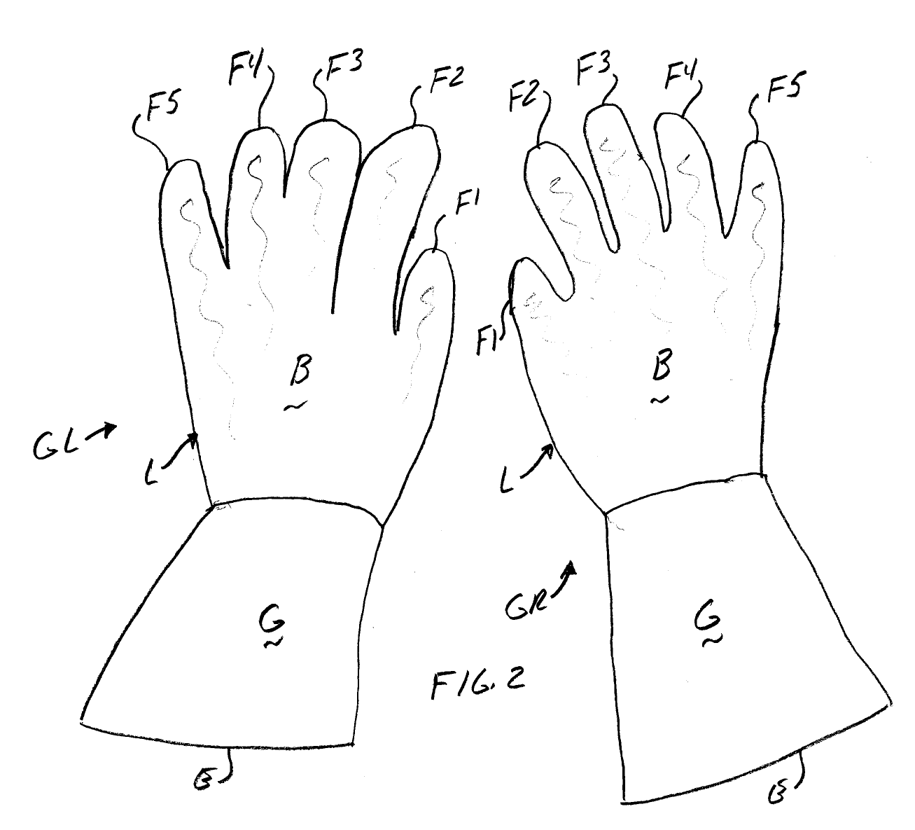

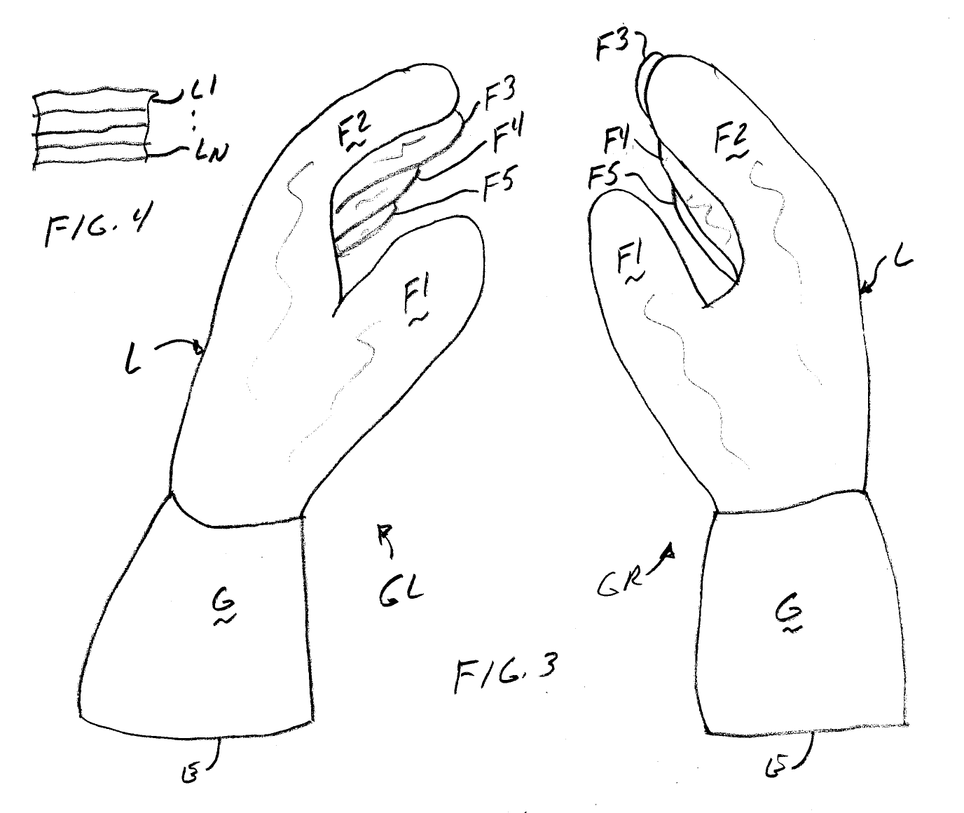

Corresponding reference characters indicate corresponding parts throughout the several views of the drawings.

### DETAILED DESCRIPTION OF INVENTION

The following detailed description illustrates the invention by way of example and not by way of limitation. This description clearly enables one skilled in the art to make and use the invention, and describes several embodiments, adaptations, variations, alternatives and uses of the invention, including what is presently believed to be the best mode of carrying out the invention. Additionally, it is to be understood that the invention is not limited in its application to the details of construction and the arrangement of components set forth in the following description or illustrated in the drawings. The invention is capable of other embodiments and of being practiced or carried out in various ways. Also, it will be understood that the phraseology and terminology used herein is for the purpose of description and should not be regarded as limiting.

Referring to the drawings, a cleansing utensil G comprises an ergonomic scrub glove GR or GL for scrubbing various surfaces to thoroughly clean them. Gloves GR and GL are made of a rubber or other material impervious to liquid and each includes a thumb and fingers respectively designated F1-F5. Each scrub glove also has a palm portion P and backhand portion B. The glove is put on by the wearer in a conventional manner; and, when worn as shown in the drawings, an open, cuff end E of each glove extends up past the wearer's wrist and a portion of their forearm. This protects these portions of body from exposure to the cleansing agents with which a scrub glove is used.

As further shown in the drawings, the fingers, palm, and backhand portion of glove G are covered and encased with a layer L of an abrasive woven mesh material. This material is, for example, a nylon material and the layer is attached to the fingers, palm and backhands portions of the glove by, for example, a flexible adhesive rubber compound material. Those skilled in the art will understand that the layer may be a unitary, one-piece layer of material formed to fit over the respective portions of scrub glove G; or, the layer may be applied in sections. That is, a separate portion of the layer is fitted over one or more of fingers F1-F5, another section of the layer over palm P and another section over backhand portion B of the glove. In another embodiment of the invention, as indicated in FIG. 4, a number of layers L1-Ln, each overlying the other, are applied to the exterior of the glove. A scrub glove with a multi-layer covering is used for more “heavy duty” cleaning operations.

In one embodiment of the invention, mesh layer L is non-detachable from the glove base but rather is bonded to the outer surface of the scrub glove by the compound used to attach it to the base. In another embodiment, layer L has a base which fits over the exterior of the glove and can be peeled off of the glove when worn with the base of a replacement layer then being fitted over the exterior of the glove. Typically this is done when the glove is either being worn by the user or fitted onto a fixture used for this purpose.

In use, scrub glove G is employed by the wearer as an ergonomic and flexible scrubbing utensil. An advantage of using the glove is that it easily conforms to the shape or contour of an object just as the wearer's hand would touch or grasp the item. This results in a better cleaning of objects and surfaces than trying to scrub them using a cloth or brush. Instead, the wearer generally employs a wiping motion over the surface of whatever is being cleaned to clean it. If there are grooves (such as, for example, where grout is routed between tiles) or depressions or recesses, the wearer uses the tip ends of the fingers to fit into and scrub these areas to clean them.

After use, the scrub glove is cleaned by rinsing it with a gentle soap solution either by hand, or by placing the glove in a dishwasher. In this regard, common, well-known over-the-counter household kitchen and bathroom cleaning solvents are used as cleaning agents on glove G. The scrub glove can also be air dried. In addition, when used to perform certain types of cleaning (as, for example, when a mold is encountered), the scrub glove is placed in a disinfectant solution as well as in a cleaning solution to clean it after use. Those skilled in the art will understand that, over time, use or damage to the scrub glove may necessitate its replacement.

Typically, the scrub glove is sold pairs comprising a right hand glove GR and a left hand glove GL. Either or both gloves are worn during cleaning. While not shown in the drawings, it will be appreciated that the gloves are available in a variety of colors. Also, the scrub gloves are available in both a light duty (i.e., dusting) cleaning version and a heavy duty version. For the light duty version of the scrub glove, the covering layer L is of a cotton/nylon weave that is replaceable. In this version, a second layer for use in buffing is fitted over the first layer.

The varieties of uses of scrub glove include, but are not limited to:

a) kitchen cleaning such as tile, grout, countertops, stoves, sinks, and floors;

b) bathroom cleaning such as tile, grout, bathtub and shower stall walls and floor, vanity or medicine cabinets mirrors and glass, toilets, and sinks;

c) upholstery, carpets, scuff marks on floors, etc. in other rooms of a house;

d) exterior cleaning of lawn furniture, cooking grills, siding, gutters, window frames and the windows; and,

e) automobile windshield, tires and tire rims, and the car's exterior to remove tar deposits, bug spatter, dirt, and grime.

Finally, it will be appreciated by those skilled in the art that scrub glove G provides an efficient, time saving, ergonomic solution to cleaning objects, and it is particularly helpful for persons suffering from arthritis or who have other movement limitations.

In view of the above, it will be seen that the several objects and advantages of the present disclosure have been achieved and other advantageous results have been obtained.

Having thus described the invention, what is claimed and desired to be secured by Letters Patent is:

1. An ergonomic cleaning utensil for expeditiously and thoroughly cleaning dirty surfaces comprising:
a scrub glove worn by a person doing the cleaning and having base portion made of a material impervious to liquids and which covers the person's fingers, palm, back of their hand, wrist and at least a portion of their forearm when worn; and,
an outer layer of an abrasive woven mesh material which encases the portion of the scrub glove covering the person's fingers, palm, and back of their hand, a cleaning solution being poured onto said outer layer for the wearer to apply the solution to a surface being cleaned by the wearer by moving their hand over and about the surface being cleaned, the base portion of the glove preventing the person's hand, wrist and forearm from coming into contact with the cleaning solution.

2. The cleaning utensil of claim 1 including a scrub glove is available in pairs so the wearer can wear a glove on either their right hand, left hand, or both hands while cleaning.

3. The cleaning utensil of claim 1 is which the base portion of the scrub glove is made of a material impervious to liquids.

4. The cleaning utensil of claim 3 is which the base portion of the scrub glove is made of a rubber material.

5. The cleaning utensil of claim 3 further in which an outer layer of the scrub glove comprises a plurality of layers of a mesh material fitting over the base of the scrub glove.

6. The cleaning utensil of claim 5 in which the outer layer is permanently attached to the base portion of the scrub glove.

7. The cleaning utensil of claim 5 in the outer layer is removably attached to the base portion of the scrub glove so to be replaceable when worn out.

8. The cleaning utensil of claim 1 in which the outer layer is cleaned using a common, over-the-counter household kitchen and bathroom cleaning solvents as a cleaning agent, by air drying, and by placing the scrub glove in a disinfectant solution.
